(19) United States
(12) Patent Application Publication
(10) Pub. No.: US 2013/0248463 A1
(43) Pub. Date: Sep. 26, 2013

(54) FIBROUS FILTERS

(71) Applicants: Philippe Westbroek, Dendermonde (BE); Bert De Schoenmaker, Oostakker (BE)

(72) Inventors: Philippe Westbroek, Dendermonde (BE); Bert De Schoenmaker, Oostakker (BE)

(73) Assignee: UNIVERSITEIT GENT, Zwijnaarde (BE)

(21) Appl. No.: 13/991,042

(22) PCT Filed: Dec. 1, 2011
(86) PCT No.: PCT/EP2011/071478

§ 371 Date: May 31, 2013

(30) Foreign Application Priority Data
Dec. 2, 2010 (EP) 10193541.9

(51) Int. Cl. B01D 39/16; B32B 37/14

(52) U.S. Cl. CPC B01D 39/1607; B32B 37/14
USPC 210/767; 210/496; 156/297; 156/298; 156/244.17

(57) ABSTRACT

A method for fabricating a micro- or nanofibrous filter is described. The method comprises obtaining at least a first carrier substrate, providing adhesive on at least a first carrier substrate, heating the adhesive above its melting temperature for inducing an interaction of at least part of the adhesive with the at least a first carrier substrate and then cooling below the melting temperature of the adhesive thus creating at least one adhesive carrier substrate. Thereafter, a layer of micro- or nanofibres is provided on the adhesive-side of the at least one adhesive carrier substrate to form a further structure. The further structure is then brought above the melting temperature of the adhesive for inducing an interaction between the adhesive and the micro- or nanofibres. Finally the temperature is again reduced below the melting temperature of the adhesive thus obtaining the micro- or nanofibrous filter.

### FIELD OF THE INVENTION

The present invention relates to filtering technology. More particularly, the present invention relates to methods for fabricating fibrous filters as well as fibrous filters thus obtained.

### BACKGROUND OF THE INVENTION

Conventional filter structures typically include a porous membrane and non-porous structural components so that a filtering element is provided that is sufficiently strong to withstand a high differential pressure. In order to allow for bi-directional flow, typically a support element, e.g. carrier substrate, is provided. In order to prevent delamination and rupture under pressure typically the membrane may be attached to the support. In one example the latter can be performed by melt bonding. Another exemplary method for attaching the membrane to the support is using an adhesive. Nevertheless, using adhesive has known disadvantages. If too much adhesive or solvent is applied, the porous membrane is blinded by the excess adhesive or solvent, decreasing the filtering capacity of the filter. Even in the case of applying a thin coat, the adhesive tends to absorb in the pores of the porous membrane, causing weak or no bonding. The latter is described for example in EP0513796 A2. EP0512796 A2 further describes a composite structure such as a filter structure comprising a support having a surface and a porous membrane formed integrally to the surface of the support. The support surface is at least slightly soluble in a solvent and the porous membrane comprises a resin soluble in the solvent and precipitated while the casting solution is in contact with a porous substrate and the surface of the support. The membrane is formed and integrally secured to the surface of the support contemporaneously.

In U.S. Pat. No. 7,789,930 a filtration device is described wherein a plurality of nanofibres is deposited directly on a support. The fibres are electrospun on the support having openings for fluid flow therethrough. For fixation between the fibres and the support, adhesive may be applied.

In NL 2002036 a system and method for producing textile material is disclosed, wherein a layer of fibres is fixed between two carrier webs. For fixation of the fibre web between the two carrier webs, a pattern of adhesive may be applied. By applying a dot pattern with relatively small dots of adhesive, the textile laminate remains flexible and remains an open structure.

There still is a need for good filters and manufacturing techniques for such filters suitable for high flux filtering applications.

### SUMMARY OF THE INVENTION

It is an object of embodiments of the present invention to provide good micro- or nanofibrous filters and methods for manufacturing them. It is an advantage of embodiments of the present that a good flux can be obtained. It it an advantage that a low flux drop can be obtained when using filters according to embodiments of the present invention.

It is an advantage of embodiments of the present invention that a strong adhesion between the carrier substrate and the micro- or nanofibres can be obtained. It thus is an advantage of embodiments according to the present invention that fibrous filters can be manufactured having a high strength, e.g. being little or not sensitive to delamination or separation of the micro- or nanofibres from the carrier substrate during normal use.

It is an advantage of embodiments according to the present invention that micro- or nanofibrous filters can be found that combine a good flux or low flux drop with a good adhesion or high strength of the fibrous filter.

It is an advantage of embodiments according to the present invention that fibrous filter structures can be obtained wherein the flux drop of the fibrous structure with carrier substrate is at most 20% lower than the same fibrous structure without carrier substrate.

It is an advantage of embodiments of the present invention that the lifetime during use of the fibrous filters obtained can be long.

It is an advantage of embodiments according to the present invention that, as a carrier substrate can be used, a relatively thin layer of micro- or nanofibres can be used. As only a thin layer of micro- or nanofibres is required, the deposition process thereof can be quick.

It is an advantage of embodiments according to the present invention that the fibrous filter can be easily manipulated, e.g. as folded, as pleated or as spiral wound filter, but not limited to these configurations.

It is an advantage of embodiments according to the present invention that electrospun nanofibres can be used, resulting in a more thin fibrous layer is required for obtaining a certain cut-off.

The above objective is accomplished by a method and device according to the present invention.

The present invention relates to a method for fabricating a micro- or nanofibrous filter, the method comprising obtaining at least a first carrier substrate, obtaining adhesive on at least a first carrier substrate, heating the adhesive up to or above its melting temperature and below the melting temperature of the first carrier substrate for inducing an interaction of the adhesive with the at least a first carrier substrate and thereafter reducing the temperature of the adhesive carrier substrate below the melting temperature of the adhesive thus creating at least one adhesive carrier substrate, and, thereafter, providing a layer of micro- or nanofibres on the adhesive-side of the at least one adhesive carrier substrate to form a further structure, bringing the further structure up to or above the melting temperature of the adhesive and below the melting temperature of the first carrier substrate and of the micro- or nanofibres for inducing an interaction between the adhesive and the micro- or nanofibres, and reducing the temperature below the melting temperature of the adhesive thus obtaining the micro- or nanofibrous filter. It is an advantage of embodiments of the present invention that a fibrous filter is obtained having a low flux drop and at the same time having a good resistance against delamination. Providing a layer of micro- or nanofibres on the adhesive-side of the at least one adhesive carrier substrate to form a further structure is thus performed after the adhesive carrier substrate has first been cooled down to a temperature below the melting temperature of the adhesive.

The step of providing adhesive on at least a first carrier substrate and heating the adhesive up to or above its melting temperature may comprise obtaining a second carrier substrate, providing adhesive between the first carrier substrate and the second carrier substrate to form an intermediate first sandwich structure so that the adhesive is present on the first carrier substrate and the second carrier substrate, heating the intermediate first sandwich structure up to or above the melting temperature of the adhesive and below melting temperature of the first and second carrier substrate for inducing an interaction of the adhesive with the first and second carrier substrate, and while the intermediate first sandwich structure is equal to or above the melting temperature of the adhesive, separating the first carrier substrate and second carrier substrate so as to obtain two adhesive carrier substrates, and selecting one of these adhesive carrier substrates as said at least one adhesive carrier substrate. It is an advantage of embodiments of the present invention that a fibrous filter is obtained wherein manipulating the intermediate products while inducing an interaction of the adhesive and the first carrier substrate can be easily done.

During or after heating the intermediate first sandwich structure and before said separating, pressure may be applied on the intermediate first sandwich structure. It is an advantage of embodiments of the present invention that using pressure allows assisting in good first interaction between the adhesive and the first carrier substrate, resulting in a fibrous filter that suffers less from flux drop than prior art fibrous filters.

Providing a layer of micro- or nanofibres on the adhesive-side of the adhesive carrier substrate for forming a further structure may comprise depositing a layer of said micro- or nanofibres directly on the adhesive-side of the adhesive carrier substrate. It is an advantage of some embodiments of the present invention that less intermediate steps need to be performed, resulting in a less complex process.

Providing a layer of micro- or nanofibres on the adhesive-side of the adhesive carrier substrate for forming a further structure may comprise first depositing a layer of micro- or nanofibres on a further carrier substrate, and then forming a further structure by bringing the at least one adhesive carrier substrate and the further carrier substrate with said deposited layer of micro- or nanofibres together so that the micro- or nanofibres are sandwiched between the at least one adhesive carrier substrate and the further carrier substrate. It is an advantage of embodiments according to the present invention that, by using a further carrier substrate whereon the deposition of micro- or nanofibres is performed, further processing steps such as for example application of pressure, becomes easier.

After bringing the further structure up to or above the melting temperature and before reducing the temperature below the melting temperature, the method may comprise applying a pressure on the further structure for assisting in the interaction between the adhesive and the micro- or nano-fibres. It is an advantage of embodiments of the present invention that using pressure allows assisting in good interaction between the adhesive and the micro- or nanofibres, resulting in a good fixation between the fibres and the carrier substrate with an adhesive side. The latter may assist in having a better resistance against de-lamination, i.e. separation of the different laminates during or induced by use.

Providing micro- or nanofibres may comprise electrospinning micro- or nano fibrous material. It is an advantage of embodiments according to the present invention that electrospun fibrous membranes can be made that have a high resistance to de-lamination, have no or little flux drop, and having good filtering properties. It is an advantage that a strong bond between the fibres and the carrier substrate, a good flux and a low cut-off for filtering can be obtained.

The adhesive may be provided as adhesive non-woven material.

The present invention also relates to a micro- or nanofibrous filter, the filter comprising a carrier substrate, an adhesive and a layer of micro- or nanofibres, part of the adhesive, e.g. at one side, being embedded in part of the carrier substrate and part of the adhesive, e.g. on the other side, being present as a coating locally around the micro- or nano fibres thus forming coated micro- or nano fibres, i.e. coated with adhesive. Cross-links may be present between fibres of the first carrier substrate and between the micro- or nano fibres. The thickness of the coating may be maximally 10 times, advantageously maximally 5 times, more advantageously below 2 times the diameter, e.g. between 2 times and 1 time the diameter of the micro- or nanofibre.

The adhesive may provide a fixation between the layer of micro- or nanofibres and the carrier substrate resistant to a flow pressure of 20 bar during at least 4 minutes.

The micro- or nanofibrous filter may induce a flux drop over the micro- or nanofibrous filter of less than 50%, advantageously less than 35%, more advantageously less than 20%.

The present invention also relates to a micro- or nanofibrous filter made using a method for fabricating as described above.

The present invention also relates to the use of a micro- or nanofibrous filter as described above for filtering. Such filtering may be effluent polishing, filtering in bioreactors, etc.

Particular and preferred aspects of the invention are set out in the accompanying independent and dependent claims. Features from the dependent claims may be combined with features of the independent claims and with features of other dependent claims as appropriate and not merely as explicitly set out in the claims.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 illustrates a method for fabricating a fibrous filter according to an embodiment of the present invention.

FIG. 2 illustrates a method for obtaining an adhesive on a carrier substrate, as can be used in a method for fabricating a fibrous filter as shown in FIG. 1.

FIG. 3 illustrates a method for providing for providing an interaction between an adhesive and micro- or nanofibres, as can be used in a method for fabricating a fibrous filter as shown in FIG. 1.

FIG. 4 illustrates a particular example of a method for fabricating a micro- or nanofibrous filter according to an embodiment of the present invention.

FIG. 5a to FIG. 5e show intermediate products (FIG. 5a to FIG. 5d) and a fibrous filter (FIG. 5e) as can be obtained using a method according to an embodiment of the present invention.

FIG. 6a to FIG. 6h show intermediate products (FIG. 6a to FIG. 6g) and a fibrous filter (FIG. 6h) as can be obtained using a particular method according to an embodiment of the present invention.

FIG. 7a and FIG. 7b illustrate enlargements of a layer of micro- or nanofibres on a carrier substrate without glue being present (FIG. 7a), for comparison with a layer of nano fibres fixed on a carrier substrate with adhesive (FIG. 7b) according to a method of an embodiment of the present invention.

FIG. 8 illustrates for reasons of comparison a stack of a carrier substrate, an adhesive and a layer of nano fibres made through direct heating of the stack.

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

In the following detailed description, specific details are set forth in order to provide a thorough understanding of the invention and how it may be practiced in particular embodiments. However it will be understood that the present invention may be practiced without these specific details. In other instances, well-known methods, procedures and techniques have not been described in detail, so as not to obscure the present invention. While the present invention will be described with respect to particular embodiments and with reference to certain drawings, the reference is not limited hereto. The drawings included and described herein are schematic and are not limiting the scope of the invention. It is also noted that in the drawings, the size of some elements may be exaggerated and, therefore, not drawn to scale for illustrative purposes.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be understood that the terms used in embodiments of the invention described herein are capable of operation in other orientations than described or illustrated herein.

It is to be understood that the term “comprising” should not be interpreted as being restricted to the steps or elements listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B.

Where in embodiments according to the present invention reference is made to microfibers or microfibrous materials or objects, reference is made to fibres having a characteristic diameter in the range 1 μm to 200 μm. Where in embodiments according to the present invention reference is made to nanofibers or nanofibrous materials or objects, reference is made to fibres having a characteristic diameter in the range 10 nm to 1 μm.

Where in embodiments according to the present invention reference is made to a carrier substrate, reference is made to a substrate that allows normal manual manipulation without damaging or breaking. The carrier substrate typically may be adapted for carrying a layer that is as such not strong enough to remain undamaged between manipulation or use.

Where in embodiments according to the present invention reference is made to an adhesive, reference is made to a material adapted for mechanically fixing a first material with a second material. Alternatively, adhesive also may be referred to as glue.

Where in embodiments according to the present invention reference is made to an adhesive carrier substrate, reference is made to a carrier substrate which has interacted with an adhesive such that, optionally after heating, other material can be mechanically fixed thereto by means of the adhesive. Where in embodiments of the present invention reference is made to an adhesive side of a carrier substrate, reference may be made to the side of the carrier substrate at which the adhesive is originally applied.

Where in embodiments according to the present invention reference is made to a cross-link, reference is made to a connection between two fibres, e.g. through a chemical bond made between two elements, through an adhesive coating embracing a contact point between two fibres in contact or through embedding of a contact point between two fibres in adhesive material.

In a first aspect, the present invention relates to a method for fabricating a micro- or nanofibrous filter, also referred to as a method for manufacturing a micro- or nanofibrous filter. The manufacturing method according to embodiments of the present invention have the advantage of providing micro- or nanofibrous filter membranes allowing a high flux of material to be filtered, while also providing a carrier substrate for the filter membrane providing strength and whereby a high resistance against delamination between the micro- or nanofibrous filter and the carrier substrate is present. The method according to embodiments of the present invention results surprisingly in a strong filter, substantially stronger than a filter manufactured by directly glueing a micro- or nanofibrous layer on the carrier substrate. According to embodiments of the present invention the adhesive first interacts with the carrier substrate, and thereafter interaction between the micro- or nanofibrous layer and at least part of the adhesive that has interacted with the carrier substrate is obtained. More particularly, according to embodiments of the present invention, the method comprises obtaining at least a first carrier substrate and obtaining adhesive on at least a first carrier substrate. The adhesive is then heated up to or above its melting temperature and below the melting temperature of the first carrier substrate for inducing an interaction of the adhesive with the at least a first carrier substrate thus creating at least one adhesive carrier substrate. Thereafter, a layer of micro- or nanofibres is provided on the adhesive-side of the at least one adhesive carrier substrate to form a further structure. The provision of a layer of micro- or nanofibres also may be performed after the adhesive carrier substrate has cooled down, e.g. below the melting temperature of the adhesive. The further structure then is brought up to or above the melting temperature of the adhesive and below the melting temperature of the first carrier substrate and of the micro- or nanofibres for inducing an interaction between the adhesive and the micro- or nanofibres. After cooling, below the melting temperature of the adhesive the micro- or nanofibrous filter is obtained. According to some embodiments of the present invention, interaction of the adhesive with the carrier substrate or with the layer of micro- or nanofibres may be enhanced by applying a pressure during the interaction process. Such a pressure may for example be between 0 kN/m² and 100 kN/m², e.g. applying about 40 kN/m², embodiments of the present invention not being limited thereby. The carrier substrates used may be a woven or non-woven substrate. It may be advantageous to use a non-woven substrate as this may improve the fixation between the layers in the fibrous filter. It may be made of any suitable material, such as for example a polyester, polyamide, polyurethane, polyvinylchloride, a polyethylene, a PTFE, etc. For the carrier substrate that stays in the final filter product, the pore sizes of the carrier substrate may be selected such that it is larger than the micro- or nanofibres. The carrier substrate should be selected such that the flux of the filter is not substantially influenced by the carrier substrate.

The adhesive used may be provided in any suitable manner, e.g. as a porous adhesive layer, e.g. a porous adhesive membrane. It may for example be a non-woven layer of adhesive. The adhesive may for example be a polyurethane. The amount of adhesive provided in the method may for example be lower than 50 g/m², more advantageously less than 25 g/m², still more advantageously less than 20 g/m², still more advantageously less than 16 g/m². The best suitable amount of adhesive for a given carrier substrate and a given micro- or nanofibrous layer may be determined in a test experiment. Such a test experiment may for example comprise a test of the drop in flux (the flux will drop if the amount of adhesive is higher) combined with a test of the strength of the device, e.g. its robustness against de-lamination. The first test can be done by measuring the flux before and after the fibrous membrane and the second test can e.g. be performed by holding the fibrous device in a flow under high pressure for a predetermined time. Combination of the lowest drop in flux and sufficient robustness to de-lamination results in the best amount of adhesive used.

The layer of micro- or nanofibres may be made of any suitable material, such as for example a polymer like polyamide, polyurethane, polyethersulfon, polyvinylidenefluoride, celluloseacetate, polyesteramide, polyethyleneoxide, polyethyleneimine, polysulfon, polytetrafluoroethylene, etc. Micro- or nanofibres have the advantage of having a large specific surface, resulting in good absorbance properties for particles to be filtered from the flux of material. The micro- or nanofibres may be made using any suitable technique, such as for example using electrospinning or applying meltblown fibres. It is an advantage of embodiments according to the present invention that electrospinning can be easily applied in the manufacturing method. By way of illustration, embodiments of the present invention not being limited thereto, electrospinning of materials may be performed for example using a multi-nozzle comprising a set of outlets for outputting solution or melt. The outlets are adapted for outputting material, e.g. solution or melt material to be used for the production of the fibres. In advantageous embodiments, a relatively large spacing between the nozzles may provide resulting in advantageous properties of the fibres deposited. Electrospinning may be performed by applying an electric field between the nozzles and a receiving surface and by moving the nozzles relative to the receiving surface. One example of electrospinning techniques that can be used is for example described in WO 2008/110538, although embodiments of the present invention are not limited thereto.

Without being limited by theory, one possible explanation of the accurate fixation between the layer of micro- or nanofibrous layer and the carrier substrate and the possibility of a high flux in such a filter may be as follows. By direct heating of a stack of a carrier substrate, an adhesive layer and a layer of micro- or nanofibres, the adhesive may be adsorbed in the pores of the layer of micro- or nanofibres thereby blocking these pores. On the contrary in embodiments of the present invention, the adhesive has first interacted with the carrier substrate and the subsequent interaction of the adhesive with the layer of micro- or nanofibres results in the pores not being blocked allowing a good flux, while also the adhesion between the micro- or nanofibres and the carrier substrate is strong.

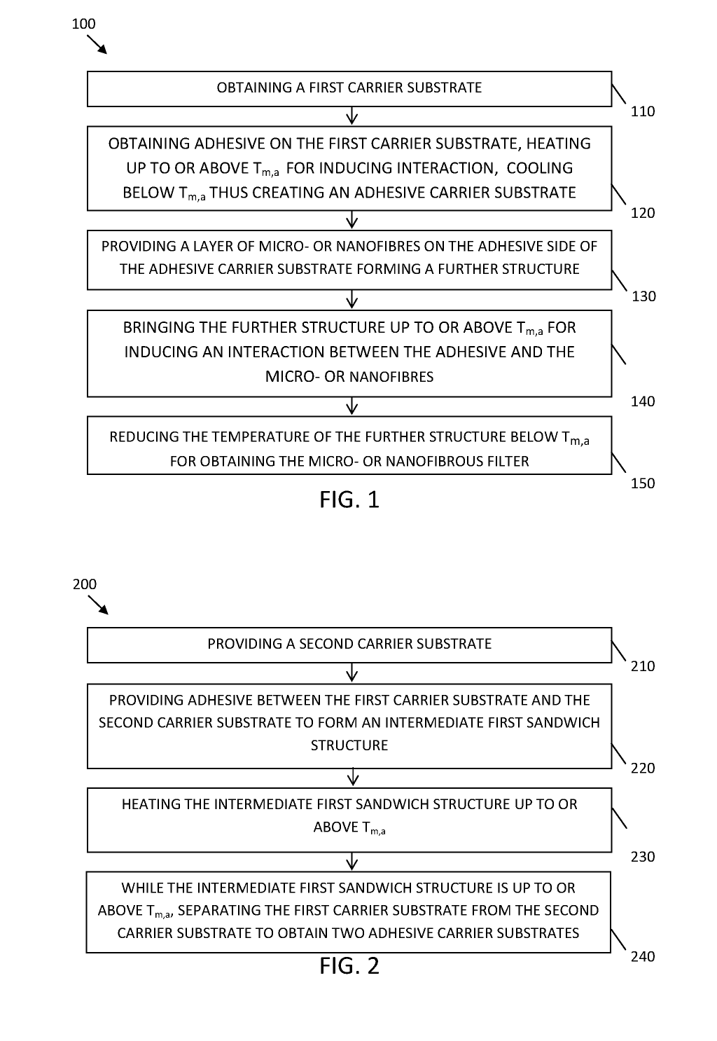

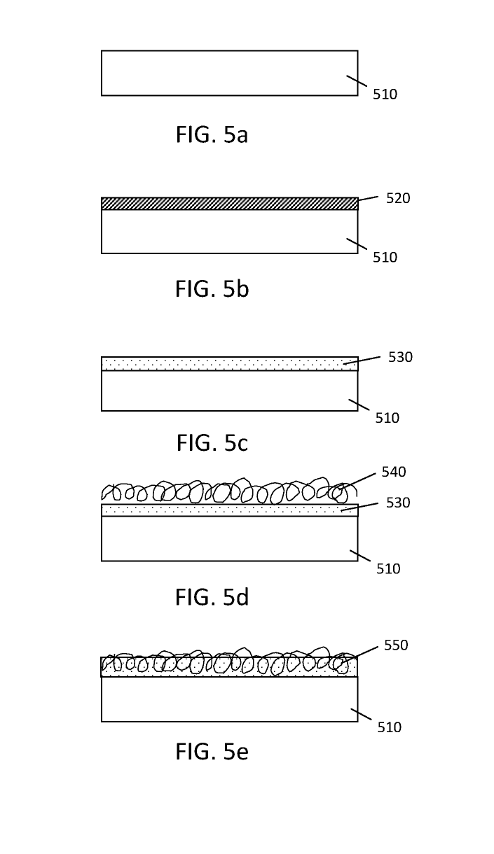

By way of illustration, embodiments of the present invention not being limited thereto, some particular examples are described below, with reference to FIG. 1 to FIG. 6h.

In a first example, a method 100 for fabricating a fibrous filter according to an embodiment of the present invention is described.

The method comprises obtaining 110 a first carrier substrate. Such a first carrier substrate may be any suitable substrate which is sufficiently porous so that the flux drop over the fibrous filter is determined by the micro- or nanofibres introduced in the fibrous filter and not by the carrier substrate.

The method also comprises obtaining 120 adhesive on the first carrier substrate. The latter can be obtained in a plurality of manners. The melting temperature of the adhesive advantageously is such that it is at least 5° C., more advantageously at least 10° C. lower than the melting temperature of the first carrier substrate.

The method also comprises heating the adhesive layer on the first carrier substrate above the melting temperature of the adhesive T_{m,a} but below the melting temperature of the carrier substrate T_{m,1c} for inducing an interation between the adhesive and the first carrier substrate. Thereafter, the carrier substrate is brought to a temperature below the melting temperature of the adhesive T_{m,a}. In this way, an adhesive carrier substrate is created.

The method further comprises obtaining 130 a layer of micro- or nanofibres on the adhesive side of the adhesive carrier substrate for forming a further structure. Obtaining a layer of micro- or nanofibres can be performed in a plurality of ways, such as for example by electrospinning, providing meltblown fibres, . . . .

The method also comprises bringing 140 the further structure above the melting temperature of the adhesive T_{m,a} for inducing an interaction between the adhesive and the micro- or nanofibres. In other words, the temperature is increased a second time above the melting temperature of the adhesive. The temperature thereby is kept substantially below the melting temperature of the first carrier substrate T_{m, 1c} and below the melting temperature of the micro- or nanofibres T_{m,f}. The temperature is e.g. advantageously at least 5° C., more advantageously at least 10° C. lower than the melting temperature of the first carrier substrate T_{m,1c} and the melting temperature of the micro- or nanofibres T_{m,f}. The method also comprises reducing the temperature of the further structure below the melting temperature T_{m,a} for obtaining the micro- or nanofibrous filter.

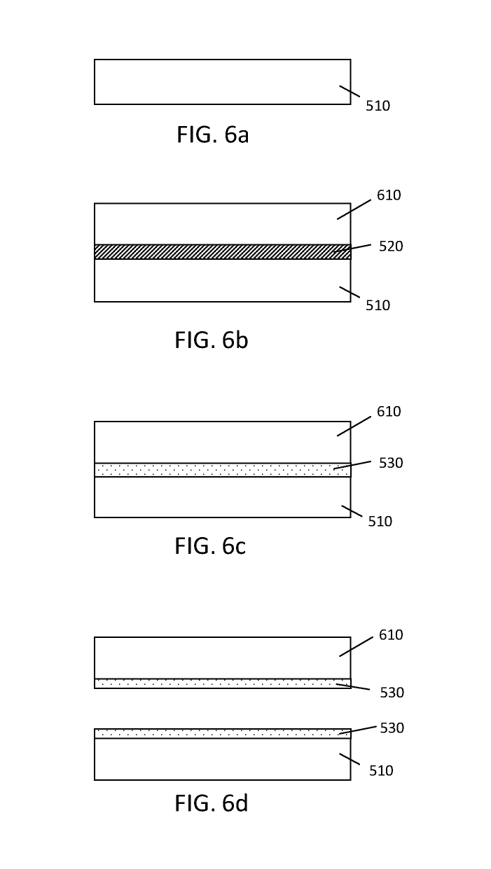

By way of illustration, embodiments of the present invention not being limited thereby, the starting products and the intermediates systems obtained during manufacturing of the fibrous filter using a method as described in the first example are shown in FIG. 5a to FIG. 5e. FIG. 5a illustrates the first carrier substrate 510, FIG. 5b illustrates the same carrier substrate 510 comprising an adhesive 520 and FIG. 5c illustrates this structure after the adhesive 520 has interacted with the first carrier substrate 510, indicated by a modified adhesive layer 530. In FIG. 5d deposited micro- or nanofibres 540 on the adhesive first carrier substrate are shown. In FIG. 5e the fibrous filter after interaction of the adhesive with the micro- or nanofibres is shown.

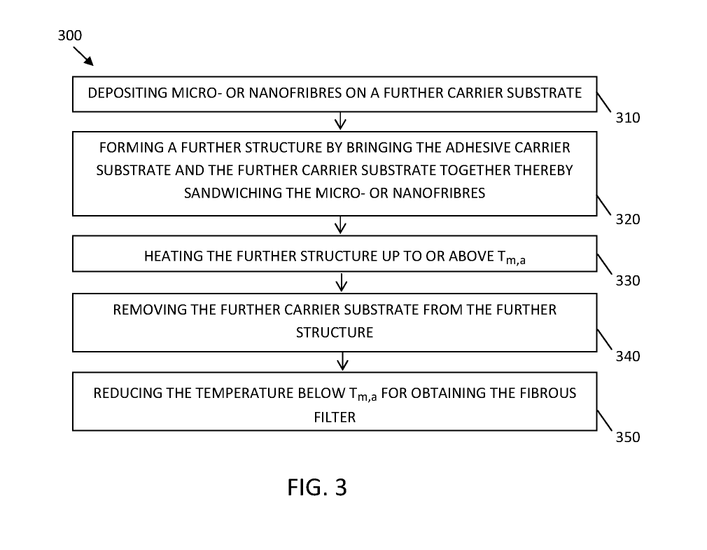

In a second example, a method as described in the first example is described, but wherein the step of obtaining an adhesive carrier substrate 120 is performed according to a predetermined process. By way of illustration, these steps are shown in a flow chart in FIG. 2, embodiments of the present invention not being limited thereby. In a first step for obtaining an adhesive carrier substrate 120, besides the first carrier substrate also a second carrier substrate is obtained 210. The second carrier substrate may be the same or similar as the first carrier substrate. Thereafter, an adhesive is provided 220 between the first carrier substrate and the second carrier substrate to from an intermediate first sandwich structure. The adhesive may have the properties as described above. The predetermined method also comprises heating 230 the intermediate first sandwich structure up to or above the melting temperature of the adhesive layer T_{m,a}. As indicated above, such heating typically is at a temperature lower, e.g. at least 5° C. or at least 10° C. lower, than the melting temperature of the first and second carrier substrate T_{m,1c} and the melting temperature of the micro- or nanofibres T_{m,f}. The predetermined method further comprises, while the intermediate first sandwich structure is above T_{m,a}, separating 240 the first carrier substrate from the second carrier substrate to obtain two adhesive carrier substrates. Such adhesive carrier substrates may be winded on a roll, after it has been cooled to a temperature lower than the melting temperature of the adhesive T_{m,a}. In some embodiments, the adhesive carrier substrate does not need to be used immediately but may be used thereafter.

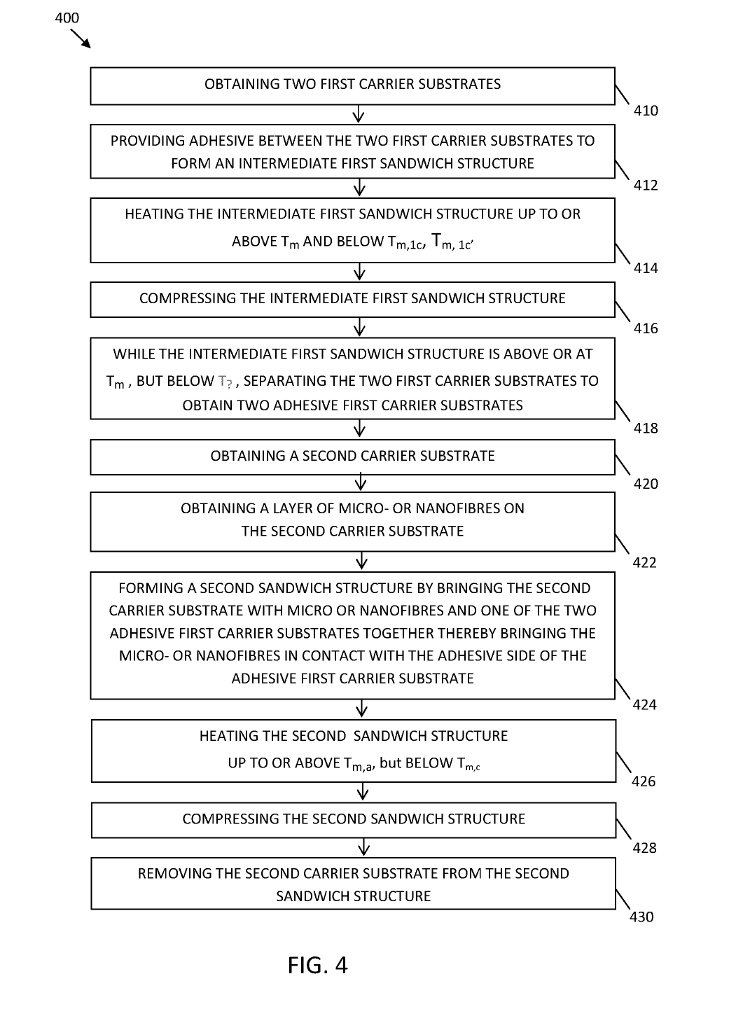

In a third example, a method as described in the first exemplary method as shown in FIG. 1 is disclosed, but wherein the steps of obtaining a layer of micro- or nanofibres on the adhesive side of the adhesive carrier substrate and creating thereof a micro- or nanonfibrous filter are performed using an intermediate carrier substrate. By way of illustration, these particular steps are illustrated in FIG. 3, embodiments of the present invention not being limited thereto. According to the present example, such a method comprises first depositing 310 micro- or nanofibres on an intermediate carrier substrate, typically not being used earlier. Such an intermediate carrier substrate may be any suitable carrier substrate and may be as the carrier substrate as described above, embodiments of the present invention not being limited thereto. Such depositing may be performed using any suitable technique, such as for example through electrospinning or by manufacturing meltblown fibres, as described above. A following step comprises forming 320 a further structure by bringing the adhesive carrier substrate and the intermediate carrier substrate together thereby sandwiching the micro- or nanofibres between the adhesive carrier substrate and the intermediate carrier substrate. The latter typically may be performed in a continuous manner rather than in batch. After the sandwich structure is formed, the method comprises heating 330 the sandwich structure up to or above the melting temperature T_{m,a} of the adhesive. Again, such heating is preferably so that the temperature thereby is kept substantially below the melting temperature of the carrier substrates T_{m, 1c} and T_{m, ic} (T_{m, ic} being the melt temperature of the intermediate carrier substrate) and below the melting temperature of the micro- or nanofibres T_{m,f}. The temperature is e.g. advantageously at least 5° C., more advantageously at least 10° C. lower than the melting temperature of the first carrier substrate T_{m,1c} and/or the melting temperature of the micro- or nanofibres T_{m,f}. Before the temperature has dropped below the melting temperature of the adhesive but after interaction has occurred between the adhesive carrier substrate and the micro- or nanofibres, the intermediate carrier substrate then is removed 340, resulting in a structure comprising the first carrier substrate and micro- or nanofibres attached thereto. Finally the temperature is reduced 350 below the melting temperature of the adhesive, resulting in the fibrous filter.

In a further example, a method for manufacturing a fibrous filter is described combining the methods as described in FIG. 1 to FIG. 3. The method 400 comprises obtaining 410 two first carrier substrates, which may or may not have the same material properties, providing adhesive 412 between the two first carrier substrates to form an intermediate first sandwich structure and heating 414 the intermediate first sandwich structure up to or above the melting temperature of the adhesive T_{m,a} but below the melting temperature of the first carrier substrates T_{m,1c}, T_{m, 1c′}. This steps allows interaction of the adhesive material with each of the first carrier substrates. In advantageous embodiments, besides heating, also compression 416 may be used for stimulating interaction of the adhesive material with each of the first carrier substrates. The heating and compression may be applied simultaneously. Compressing may be performed using any suitable pressure. In one example, the pressure may be between 0 kN/m² and 100 kN/m², e.g. 40 kN/m². Then, while the intermediate first sandwich structure is at or above its melting temperature T_{m,a} but below the melting temperature of the first carrier substrates T_{m,1c}, T_{m, 1c′}, the first carrier substrate are separated 418 and two adhesive first carrier substrates are obtained. It is to be noticed that the separate adhesive first carrier substrates typically will be cooled below the melting temperature of the adhesive after the separation. Although the contact adhesive properties of the adhesive typically will be only present when the adhesive is above its melting temperature, further reference will be made to this structure by the term adhesive first carrier substrate or adhesive carrier substrate. The different steps described up to now for the exemplary method typically may be done in a single continuous process, although embodiments of the present invention are not limited thereto. The following steps of the exemplary method also may be done in a single continuous process, which typically may be a different continuous process than the first continuous process in order to deal with the difference in speed of manufacturing (e.g. speed in depositing micro- or nanofibres). In step 420 a second carrier substrate is obtained and step 422 describes obtaining on the second carrier substrate a layer of micro- or nanofibres. The latter can be performed using any suitable technique as described above, e.g. using electrospinning or using meltblown fibres. In step 424 the second carrier substrate with micro- or nanofibres is brought into contact with one of the adhesive first carrier substrates, so that a second sandwich structure is formed wherein the micro- or nanofibres are sandwiched between the second carrier substrate and the first adhesive carrier substrate. Heating 426 the second sandwich structure then may be performed so that interaction between the adhesive of the first adhesive carrier substrate and the micro- or nanofibres occurs. Combined with said heating, also pressure may be used for promoting interaction between the adhesive and the fibres. The heating 426 and compression 428 may be applied simultaneously. Compressing may be performed using any suitable pressure. In one example, the pressure may be between 0 kN/m² and 100 kN/m², e.g. 40 kN/m². After interaction has occurred, the second carrier substrate is removed 430 from the second sandwich structure, before the temperature of the second sandwich structure has dropped below the melting temperature of the adhesive. The remaining structure then typically is cooled, either forced or spontaneously to a temperature below the melting temperature of the adhesive, the remaining structure being the fibrous filter which was to be manufactured.

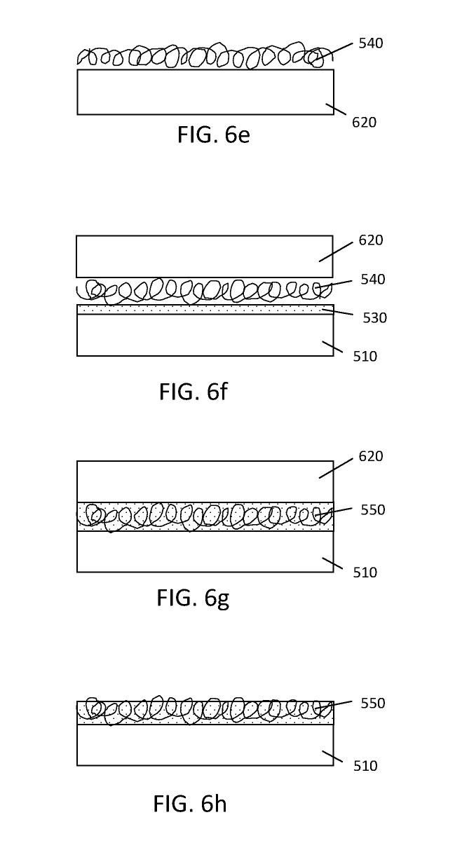

By way of illustration, embodiments of the present invention not being limited thereby, the starting products and the intermediates systems obtained during manufacturing of the fibrous filter using a method as described in the fourth example are shown in FIG. 6a to FIG. 6h. FIG. 6a illustrates a first carrier substrate 510, FIG. 6b illustrates an adhesive layer 520 sandwiched between first and second carrier substrates 510, 610 and FIG. 6c illustrates the first sandwich structure upon heating up to or above the melting temperature of the adhesive layer, indicating the heated adhesive layer 530. FIG. 6d illustrates two adhesive first carrier substrates after separating the first sandwich structure. In FIG. 6e a further substrate 620 with a layer of micro- or nanofibres 540 deposited thereon is shown. FIG. 6f illustrates the formation of a second sandwich structure by combining the structure of FIG. 6e with one of the adhesive first carrier substrates as shown in FIG. 6d. After heating up to or above the melting temperature of the adhesive, such a second sandwich structure is as illustrated in FIG. 6g whereby the adhesive has interacted with the micro- or nanofibres, as shown by layer 550. The fibrous filter is shown FIG. 6h, obtained after removing the second carrier substrate 620 from the second sandwich structure shown in FIG. 6g.

It has surprisingly been found that providing first an interaction between the adhesive and the carrier substrate and thereafter providing an interaction between the thus formed adhesive carrier substrate and the micro- or nanofibres, results in a fibrous filter having a low flux drop determined by the flux properties of the micro- or nanofibres layer and having a strong fibrous filter that does little or not suffer from separation of the micro- or nanofibres layer and the carrier substrate upon use. The latter is advantageous, as it results in a high quality filter.

In a second aspect of the present invention, micro- or nanofibrous filters are described. According to some embodiments of the present invention, micro- or nanofibrous filters are envisaged as obtained using a method of manufacturing as described in the first aspect. According to some embodiments of the present invention, a micro- or nanofibrous filter is described comprising a carrier substrate, an adhesive and a layer of micro- or nanofibrous whereby the adhesive is being at least partly embedded in part of the carrier substrate and the adhesive also is being present as a local coating around at least some of the micro- or nano fibres. In at least some embodiments of the present invention, cross-links of adhesive material are present between the micro- or nano fibres. According to some embodiments, a micro- or nanofibrous filter is disclosed wherein the adhesive provides a fixation between the layer of micro- or nanofibres and the carrier substrate is resistant to a flow pressure of 20 bar during at least 4 minutes. The latter typically may be tested by providing a flow of clean water at a pressure of 20 bar at the filter and evaluating the occurrence of delamination. In the test example used, application of the pressure is obtained by using a high pressure water cleaner (normal operational pressure is typically 100 bar) and position it at a a distance of 50 cm from the filter. This results in an actual pressure of around 20 bar. This pressure is applied to the side of the filter that contains the micro- or nanofibres and the pressure is maintained for 4 minutes to typically an A4 size of the filter. Evaluation is done visually and by testing the clean water flux of the filter before and after the 20 bar test. Flux preferably should remain in the same order of magnitude. If much larger, it means the micro- or nanofibrous layer is at least partly destroyed. The latter may be evaluated as identifying areas with a size larger than 1 cm² where the micro- or nanofibrous layer is not in contact with the carrier substrate. According to some embodiments of the present invention, a micro- or nanofibrous filter is disclosed wherein the flux drop over the micro- or nanofibrous filter is less than 50%, advantageously less than 35%, more advantageously less than 20%. Whereas the above embodiments have been described as separate embodiments, the present aspect also includes embodiments comprising two or more of the above described aspects.

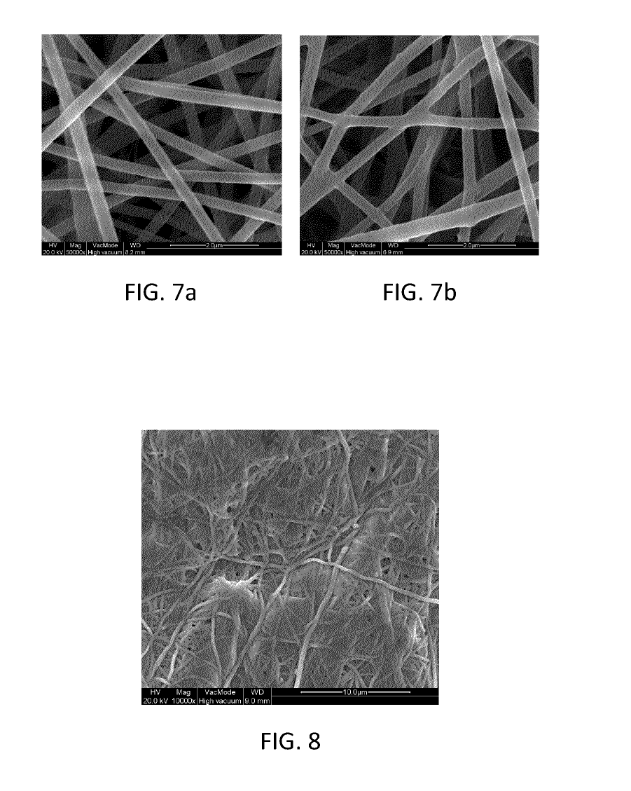

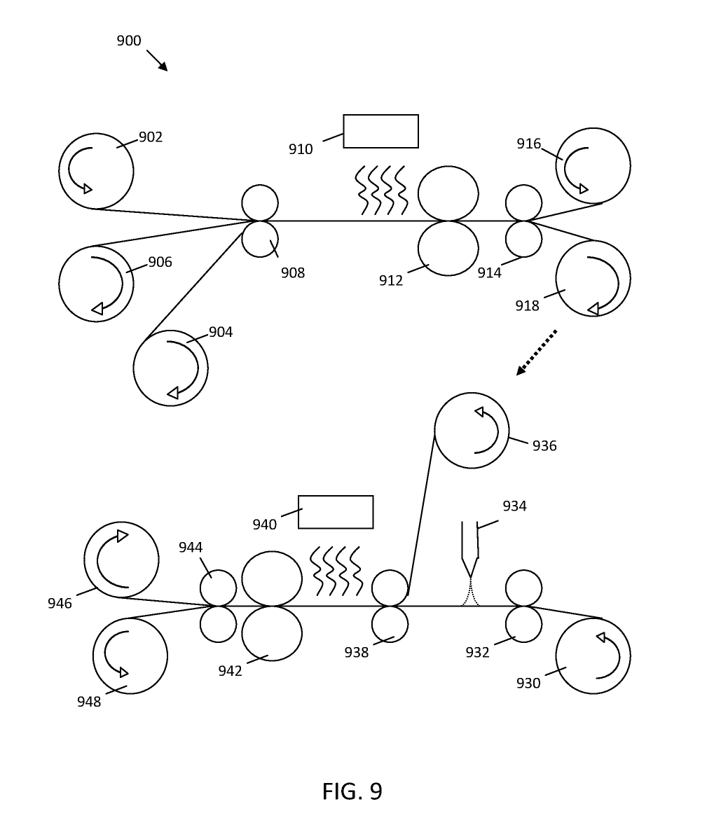

By way of illustration, embodiments of the present invention not being limited thereby, scanning electron microscope images are shown for a micro- or nanofibrous filter according to an embodiment of the present invention. FIG. 7a and FIG. 7b illustrate a layer of nanofibres on a carrier substrate without an adhesive (FIG. 7a, provided for comparison) and a layer of nanofibres fixed on a carrier substrate with adhesive (FIG. 7b) using a method according to an embodiment of the present invention. It can be seen in FIG. 7b that adhesive material is present as a coating around the fibers and that cross-links between the fibres are formed. It also can be seen that the porous structure is maintained. By way of comparison, an example of a filter made using a method of directly heating of a stack of a carrier substrate, an adhesive and a layer of nanofibres is also shown in FIG. 8, illustrating that a substantial part of the pores in between the fibres are filled with glue.

In a third aspect, the present invention relates to the use of a micro- or nanofibrous filter for filtering purposes. Such filtering may include effluent polishing, membrane bioreactor filtering, beer filtration, blood filtration, biomass harvesting, pharmaceutical filtration, wine filtration, fruit juice filtration, prefiltration step for Reverse osmosis systems, . . . .

In a fourth aspect, the present invention relates to a system for manufacturing a micro- or nanofibrous filter. Such a system may be a system for manufacturing a micro- or nanofibrous filter on large surfaces and in continuous or quasi-continuous mode. The system may comprise a means for providing a first carrier substrate, a means for obtaining an adhesive on the first carrier substrate, a means for heating the adhesive up to or above its melting temperature and below the melting temperature of the first carrier substrate for inducing an interaction of the adhesive with the at least a first carrier substrate thus creating at least one adhesive carrier substrate, a means for providing, after said interaction of the adhesive with the first carrier substrate, a layer of micro- or nanofibres on the adhesive-side of the at least one adhesive carrier substrate to form a further structure, a means for bringing the further structure up to or above the melting temperature of the adhesive and below the melting temperature of the first carrier substrate and of the layer of micro- or nanofibres for inducing an interaction between the adhesive and the micro- or nanofibres, and a means for reducing the temperature below the melting temperature of the adhesive thus obtaining the micro- or nanofibrous filter.

By way of illustration, embodiments of the present invention not being limited thereto, an example of such a system is shown in FIG. 9. The system 900 according to the example of FIG. 9 shows two sub-systems, a first sub-system wherein the adhesive carrier substrate is made and a second sub-system wherein the fibrous filter is made.

The system 900 comprises a means 902 for providing a first carrier substrate. The latter may for example be a roll or winding system, although embodiments of the present invention are not limited thereto. The means for obtaining an adhesive on the first carrier substrate may comprise any suitable means for providing adhesive, in the present example being a roll or winding system 906 for providing a layer of adhesive, a roll or winding system 904 for providing a layer of a second carrier substrate as a web, and guiding means 906 for sandwiching the layer of adhesive between the first carrier substrate and the second carrier substrate. The system furthermore comprises a heater 910 for heating the adhesive to or above its melting temperature and optionally also pressure inducing means for inducing pressure for increasing the interaction. The system according to the example of FIG. 9 also comprises guiding means 914 for guiding the heated sandwich structure and a means 916, 918 for separating the sandwich into two adhesive carrier substrates.

A second subsystem comprises a means for providing a layer of micro- or nanofibres on the adhesive carrier substrate. In the present example this is provided through a roll or winding system 930 for providing a further carrier substrate, a guiding means 932, an electrospinning unit 934, a roll or winding system for providing the adhesive carrier substrate obtained using the first subsystem, a guiding means 938 for bringing the adhesive layer in contact with the adhesive carrier substrate, a heater 940 for bringing the adhesive up to or above its melting temperature, optional additional pressure inducing rolls 942 and a guiding means 944 and roll or winding systems 946, 948 for obtaining on one winding system 946 the fibrous filter, while obtaining on the other winding system 948 the further carrier substrate. Variations of the system can be easily implemented by the person skilled in the art, e.g. the provision of the layer of micro- or nanofibres may be done directly on the adhesive carrier substrate, removing the need for some components in the system. As indicated the pressure inducing means is optional, both in the first and the second subsystem.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to include any specific characteristics of the features or aspects of the invention with which that terminology is associated.

1. A method for fabricating a micro- or nanofibrous filter, the method comprising:
obtaining at least a first carrier substrate,
providing adhesive on the at least first carrier substrate, heating the adhesive up to or above its melting temperature and below the melting temperature of the at least first carrier substrate for inducing an interaction of the adhesive with the at least first carrier substrate and thereafter reducing the temperature below the melting temperature of the adhesive thus obtaining at least one adhesive carrier substrate,
thereafter, providing a layer of micro- or nanofibres on the adhesive-side of the at least one adhesive carrier substrate to form a further structure,
bringing the further structure up to or above the melting temperature of the adhesive and below the melting temperature of the at least first carrier substrate and of the micro- or nanofibres for inducing an interaction between the adhesive and the micro- or nanofibres, and
reducing the temperature below the melting temperature of the adhesive thus obtaining the micro- or nanofibrous filter.

2. A method according to claim 1, wherein the step of providing adhesive on the at least first carrier substrate and heating the adhesive up to or above its melting temperature comprises:
obtaining a second carrier substrate,
providing adhesive between the first carrier substrate and the second carrier substrate to form an intermediate first sandwich structure so that the adhesive is present on the first carrier substrate and the second carrier substrate,
heating the intermediate first sandwich structure up to or above the melting temperature of the adhesive and below melting temperature of the first and second carrier substrate for inducing an interaction of the adhesive with the first and second carrier substrate, and
while the intermediate first sandwich structure is equal to or above the melting temperature of the adhesive, separating the first carrier substrate and second carrier substrate so as to obtain two adhesive carrier substrates, and selecting one of these adhesive carrier substrates as said at least one adhesive carrier substrate.

3. A method according to claim 2, wherein during or after heating the intermediate first sandwich structure and before said separating, pressure is applied on the intermediate first sandwich structure.

4. A method according to claim 1, wherein providing a layer of micro- or nanofibres on the adhesive-side of the adhesive carrier substrate for forming a further structure comprises:
depositing a layer of said micro- or nanofibres directly on the adhesive-side of the adhesive carrier substrate.

5. A method according to claim 1, wherein providing a layer of micro- or nanofibres on the adhesive-side of the adhesive carrier substrate for forming a further structure comprises:
first depositing the layer of micro- or nanofibres on a further carrier substrate, and then
forming the further structure by bringing the at least one adhesive carrier substrate and the further carrier substrate with said deposited layer of micro- or nanofibres together so that the micro- or nanofibres are sandwiched between the at least one adhesive carrier substrate and the further carrier substrate.

6. A method according to claim 1, wherein after bringing the further structure up to or above the melting temperature and before reducing the temperature below the melting temperature, the method comprises applying a pressure on the further structure for assisting in the interaction between the adhesive and the micro- or nano-fibres.

7. A method according to claim 1, wherein providing micro- or nanofibres comprises electrospinning micro- or nano fibrous material.

8. A method according to claim 1, wherein the adhesive is provided as adhesive non-woven material.

9. A micro- or nanofibrous filter, the filter comprising a carrier substrate, an adhesive and a layer of micro- or nanofibres, part of the adhesive being embedded in part of the carrier substrate and part of the adhesive being present as a coating locally around the micro- or nano fibres thus forming coated micro- or nano fibres.

10. A micro- or nanofibrous filter according to claim 9, wherein cross-links between fibres of the first carrier substrate and between the micro- or nano fibres are present.

11. A micro- or nanofibrous filter according to claim 9, the adhesive providing a fixation between the layer of micro- or nanofibres and the carrier substrate resistant to a flow pressure of 20 bar during at least 4 minutes.

12. A micro- or nanofibrous filter according to claim 9, wherein the flux drop over the micro- or nanofibrous filter is less than 50%.

13. A method for filtering using a micro- or nanofibrous filter comprising a carrier substrate, an adhesive and a layer of micro- or nanofibres, part of the adhesive being embedded in part of the carrier substrate and part of the adhesive being present as a coating locally around the micro- or nanofibres thus forming coated micro- or nano fibres.

14. (canceled)

15. A method for filtering according to claim 13, wherein filtering comprises effluent polishing.
